(19) United States
(12) Patent Application Publication
(10) Pub. No.: US 2022/0043532 A1
(43) Pub. Date: Feb. 10, 2022

(54) TOUCH CONTROL APPARATUS, TOUCH CONTROL DRIVE METHOD AND TOUCH CONTROL DISPLAY PANEL

(71) Applicant: Wuhan China Star Optoelectronics Semiconductor Display Technology Co., Ltd., Wuhan, Hubei (CN)

(72) Inventor: Xiaoliang FENG, Wuhan, Hubei (CN)

(73) Assignee: Wuhan China Star Optoelectronics Semiconductor Display Technology Co., Ltd., Wuhan, Hubei (CN)

(21) Appl. No.: 17/278,670

(22) PCT Filed: Apr. 9, 2019
(86) PCT No.: PCT/CN2019/081972

§ 371 Date: Mar. 23, 2021

(30) Foreign Application Priority Data
Dec. 14, 2018 (CN) 201811533558.0

(51) Int. Cl. G06F 3/044; G06F 3/041; G06F 3/0354

(52) U.S. Cl. CPC G06F 3/0442; G06F 3/04162; G06F 3/04164; G06F 2203/04112; G06F 3/03545; G06F 2203/04111; G06F 3/0448

(57) ABSTRACT

Provided in the present application are a touch control apparatus, a touch control drive method and a touch control display panel. The touch control apparatus comprises a touch control electrode, a signal wiring and a drive circuit. The drive circuit comprises a touch control drive circuit and a stylus drive circuit. The touch control electrode, the signal wiring, the touch control drive circuit and the stylus drive circuit constitute a stylus detection circuit, and the touch control electrode, the signal wiring and the touch control drive circuit constitute a non-stylus detection circuit.

### BACKGROUND

### Field

The present disclosure relates to a technical field of display apparatuses, and more particularly to a touch control apparatus, a touch control driving method, and a touch control display panel thereof.

### Background

Currently, in a field of display panels, touch display panels have become mainstream display products. In addition to detecting or contacting (collectively referred to as proximity) the human body, the touch display panel can also be used to detect a proximity pen or stylus tip, so that the user can more accurately control the trajectory of the stylus tip.

In order to simultaneously meet two touch modes of non-touch pen touch control and stylus touch control, a touch layer and a stylus sensing layer need to be arranged at the same time in the display panel. Conventionally, a stylus introduced with an additional touch-sensitive layer is typically attached to the back of a touch display screen. In an aspect, the arrangement of the stylus sensing layer increases the thickness of the touch display screen. In another aspect, because the stylus sensing layer has a far distance from a writing surface of the stylus, interference of the electromagnetic waves can be present, resulting in poor writing of the stylus.

Therefore, there is a need in the art for a touch device and a touch driving method, and a touch display panel to solve the above-mentioned problems.

### SUMMARY OF THE DISCLOSURE

The present disclosure provides a touch control apparatus, a touch control driving method, and a touch control display panel, so as to solve the problem that the touch control layer and the touch control pen sensing layer in the existing touch control apparatus need to be arranged separately, and the problems that the thickness of the touch control apparatus is large and the sensing signals of the touch control pen are weak can be solved.

In order to solve above-mentioned problems, the technical scheme provided by the present disclosure is provided as follows.

According to one embodiment of the present disclosure, a touch control apparatus comprises:

a touch control electrode;

a signal wiring;

a driving circuit comprising a touch control drive circuit and a touch control pen drive circuit;

wherein the touch control electrode, the signal wiring, the touch control drive circuit, and the touch control pen drive circuit are configured to form a touch control pen detection circuit, and wherein the touch control electrode, the signal wiring and the touch control drive circuit are configured to form a non-touch control pen detection circuit.

In the touch control apparatus, the signal wiring comprises a first signal wiring and a second signal wiring, and the touch control electrode is connected with the touch control drive circuit through the first signal wiring, and the touch control electrode is connected with the touch control pen drive circuit through the second signal wiring.

In the touch control apparatus, the touch control pen drive circuit comprises a touch control pen wiring, and the touch control pen wires is in one-to-one correspondence with the second signal wirings;

wherein a switch element is arranged on the touch control pen wiring, and the switch element is used for controlling the connection and disconnection of the touch control pen drive circuit and the touch control electrode.

In the touch control apparatus, the touch control apparatus further comprises an identification module for identifying a touch state of the touch control apparatus;

wherein in a stylus touch state, the switch element is in communication and a touch control pen detection circuit operates, and in a non-stylus touch state, the switch element is opened and a non-touch control pen detection circuit operates.

In the touch control apparatus, the identification module comprises a capacitance detection unit for detecting whether a capacitance is generated at a touch control electrode or not.

In the touch control apparatus, the touch control apparatus further comprises a binding pad, and the binding pad is arranged between the signal wiring and the driving circuit.

In the touch control apparatus, the touch control electrode comprises a first touch control electrode set and a second touch control electrode set that are insulated from each other;

wherein the first touch control electrode set comprises at least two first touch control electrode units that are communicated with each other, where the first touch control electrode set is arranged in a first direction;

wherein the second touch control electrode set comprises at least two second touch control electrode units that are communicated with each other, the second touch control electrode set is arranged in a second direction;

wherein the first touch control electrode units and the second touch control electrode units are metal grids, and two ends of the first touch control electrode set and two ends of the second touch control electrode set are led out of the second signal wirings to be connected with the touch control pen drive circuit.

The touch control apparatus further comprises an insulating layer and a bridging layer;

wherein the insulating layer is arranged on the touch control electrode;

wherein the bridge layer is arranged on the insulating layer;

wherein the first touch control electrode units are communicated, and the adjacent second touch control electrode units are communicated through the bridging layer.

In the touch control apparatus, the first touch control electrode unit and the second touch control electrode unit are a diamond-shaped grid electrode.

According to another embodiment of the present disclosure, a touch control driving method of a touch control apparatus is provided, wherein the touch control apparatus comprises a touch control electrode, a signal wiring, and a driving circuit, and the driving circuit comprises a touch control driving circuit and a touch control pen driving circuit;

wherein the touch control electrode, the signal wiring, the touch control drive circuit, and the touch control pen drive circuit are configured to form a touch control pen detection circuit, and wherein the touch control electrode, the signal wiring and the touch control drive circuit are configured to form a non-touch control pen detection circuit;

the touch control driving method comprising the steps of:

at a step S10, performing touch control on the touch control apparatus;

at a step S20, determining, by the touch control apparatus, the touch control state, and transmitting, by the driving circuit, a control signal to the touch control electrode, and identifying a touch position;

wherein in a stylus touch state, the touch control pen detection circuit operates, and in a non-stylus touch state, the non-touch control pen detection circuit operates.

According to another embodiment of the present disclosure, a touch control display panel is provided and comprises a touch control apparatus and a display panel, the touch control apparatus comprising:

a touch control electrode;

a signal wiring;

a driving circuit comprising a touch control drive circuit and a touch control pen drive circuit;

wherein the touch control electrode, the signal wiring, the touch control drive circuit, and the touch control pen drive circuit are configured to form a touch control pen detection circuit, and wherein the touch control electrode, the signal wiring and the touch control drive circuit are configured to form a non-touch control pen detection circuit.

In the touch control display panel, the signal wiring comprises a first signal wiring and a second signal wiring, and the touch control electrode is connected with the touch control drive circuit through the first signal wiring, and the touch control electrode is connected with the touch control pen drive circuit through the second signal wiring.

In the touch control display panel, the touch control pen drive circuit comprises a touch control pen wiring, and the touch control pen wires is in one-to-one correspondence with the second signal wirings;

wherein a switch element is arranged on the touch control pen wiring, and the switch element is used for controlling the connection and disconnection of the touch control pen drive circuit and the touch control electrode.

In the touch control display panel, the touch control apparatus further comprises an identification module for identifying a touch control state of the touch control apparatus;

wherein in a stylus touch state, the switch element is in communication and the touch control pen detection circuit operates, and in a non-stylus touch state, the switch element is opened and the non-touch control pen detection circuit operates.

In the touch control display panel, the identification module comprises a capacitance detection unit for detecting whether a capacitance is generated at a touch control electrode or not.

The touch control display panel further comprises a binding pad, and the binding pad is arranged between the signal wiring and the driving circuit.

In the touch control display panel, the touch control electrode comprises a first touch control electrode set and a second touch control electrode set that are insulated from each other;

wherein the first touch control electrode set comprises at least two first touch control electrode units that are communicated with each other, where the first touch control electrode set is arranged in a first direction;

wherein the second touch control electrode set comprises at least two second touch control electrode units that are communicated with each other, the second touch control electrode set is arranged in a second direction;

wherein the first touch control electrode and the second touch control electrode are metal grids, and the two ends of the first touch control electrode set and the two ends of the second touch control electrode set are led out of second signal wirings are connected with the touch control pen drive circuit.

The touch control display panel further comprises an insulating layer and a bridging layer;

wherein the insulating layer is arranged on the touch control electrode;

wherein the bridge layer is arranged on the insulating layer;

wherein the first touch control electrode units are communicated, and the adjacent second touch control electrode units are communicated through the bridging layer.

In the touch control display panel, the first touch control electrode unit and the second touch control electrode unit are a diamond-shaped grid electrode.

The present disclosure has following beneficial effects: the touch control electrode is configured to be time-division multiplexing, so that the touch control electrode can be driven by the touch control drive circuit, and can also be driven by the touch control pen drive circuit. The touch control electrode is used for sensing the position of the touch control pen, so that the touch control pen sensing layer is omitted. The thickness of the touch control apparatus can be reduced, the induction signals of the touch control pen can be improved, and the product cost can be reduced.

### BRIEF DESCRIPTION OF THE DRAWINGS

The following embodiments refer to the accompanying drawings for exemplifying specific implementable embodiments of the present disclosure in a suitable computing environment. It should be noted that the exemplary described embodiments are configured to describe and understand the present disclosure, but the present disclosure is not limited thereto.

FIG. 1 is a schematic structural diagram of a touch control apparatus according to a first embodiment of the present disclosure.

FIG. 2 is a partial structural schematic diagram of a driving circuit and a signal wiring according to the second embodiment of the present disclosure.

FIG. 3 is a schematic structural diagram of a first touch control electrode unit and a second touch control electrode unit according to a third embodiment of the present disclosure.

### DETAILED DESCRIPTION OF THE PREFERRED EMBODIMENTS

The following embodiments refer to the accompanying figures for exemplifying specific implementable embodiments of the present disclosure in a suitable environment. It should be noted that the exemplary described embodiments are configured to describe and understand the present disclosure, but the present disclosure is not limited thereto. Directional terms, such as an upper side, a lower side, a front side, a back side, a left side, a right side, an inner side, an outer side, and a lateral side, mentioned in the present disclosure are only for reference. Therefore, the directional terms are used for describing and understanding rather than limiting the present disclosure. In the figures, units having similar structures are used for the same reference numbers.

The present disclosure provides a touch control apparatus, a touch control driving method and a touch control display panel, so as to solve the problem that the touch control layer and the touch control pen sensing layer in the existing touch control apparatus need to be arranged separately, and the problems that the thickness of the touch control apparatus is large and the sensing signals of the touch control pen are weak can be solved.

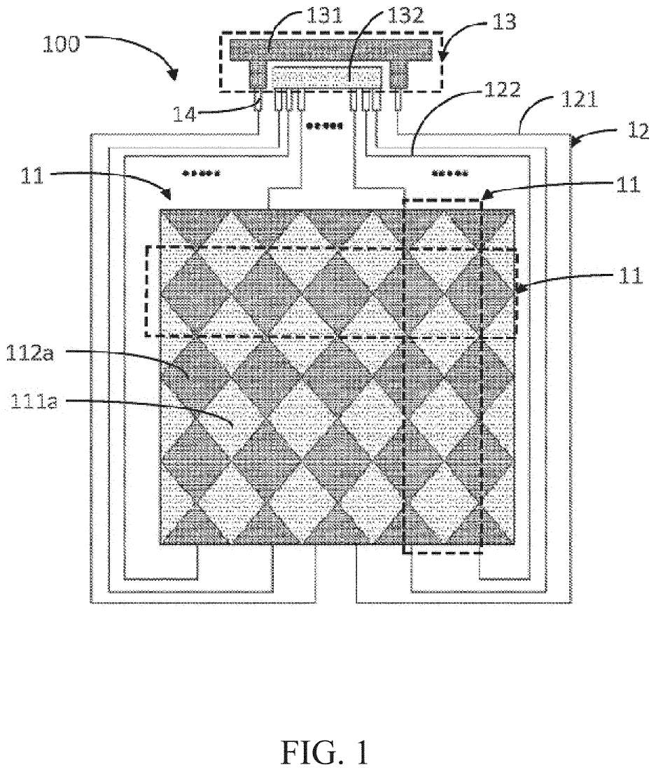

Please refer to FIG. 1. FIG. 1 is a schematic structural diagram of a touch control apparatus 100 according to a first embodiment of the present disclosure.

According to an aspect of the disclosure, a touch control apparatus is provided and includes a touch control electrode 11, a signal wiring 12, and a driving circuit 13.

In an embodiment, the touch control electrode 11 includes a first touch control electrode set 111 and a second touch control electrode set 112 that are insulated from each other.

The first touch control electrode set 111 includes at least two first touch control electrode units 111a that are communicated with each other, where the first touch control electrode set 111 is arranged in a first direction.

The second touch control electrode set 112 includes at least two second touch control electrode units 112a that are communicated with each other, where the second touch control electrode set 112 is arranged in a second direction.

In an embodiment, the first touch control electrode units 111a and the second touch control electrode units 112a are metal grids, and two ends of each set of the first touch control electrode sets 111 and two ends of each set of the second touch control electrode sets 112 are led out of the second signal wirings 122 to be connected with a touch control pen drive circuit 132, e.g., a stylus drive circuit.

In an embodiment, in order to improve the accuracy of touch control of a stylus, and the second signal wirings 122 are led from middle parts of the two ends of each of the touch control electrode units.

In an embodiment, the first touch control electrode unit 111a is an induction electrode and the second touch control electrode unit 112a is a driving electrode.

In an embodiment, the touch control apparatus 100 further includes an insulating layer and a bridging layer.

The insulating layer is arranged on the touch control electrode 11, wherein the material of the insulating layer includes one of silicon nitride and silicon oxide.

The bridging layer is arranged on the insulating layer, and the material of the bridging layer includes conductive metal.

The first touch control electrode units 111a are communicated with each other, and adjacent second touch control electrode units 112a are communicated through the bridging layer.

In an embodiment, the touch control electrode 11 is disposed on a substrate.

In an embodiment, the touch control apparatus 100 further includes a protection layer arranged on the bridge connection layer.

In an embodiment, the bridging layer and the signal wirings 12 are arranged in a same layer.

In an embodiment, the touch control electrode 11 is connected with the driving circuit 13 through the signal wirings 12.

The driving circuit 13 includes a touch control drive circuit 131 and a touch control pen drive circuit 132, e.g., a stylus drive circuit.

In an embodiment, when the touch control apparatus 100 is applied to a display panel, the touch control circuit and the touch control pen drive circuit 132 are all arranged on a circuit board of the display panel.

In an embodiment, each of the signal wirings 12 includes a first signal wiring 121 and a second signal wiring 122, the touch control electrode 11 is connected with the touch control drive circuit 131 through the first signal wiring 121, and the touch control electrode 11 is connected with the touch control pen drive circuit 132 through the second signal wiring 122.

The touch control electrode 11, the signal wiring 12, the touch control drive circuit 131, and the touch control pen drive circuit 132 are configured to form a touch control pen detection circuit, e.g., a stylus detection circuit, where the touch control electrode 11, the signal wiring 12, and the touch control drive circuit 131 are configured to form a non-touch control pen detection circuit, e.g., a non-stylus detection circuit.

In a stylus touch state, the touch control pen detection circuit operates to determine a touch position of the stylus. In a non-stylus touch state, the non-touch control pen detection circuit operates to determine a touch position of the non-stylus.

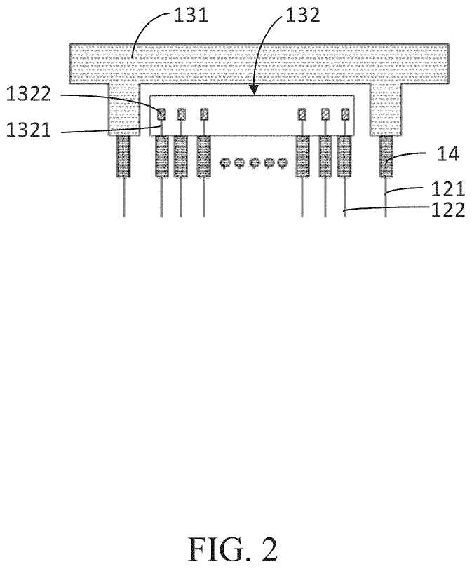

Please refer to FIG. 2. FIG. 2 is a partial structural schematic diagram of a driving circuit 13 and signal wirings 12 according to the second embodiment of the present disclosure.

In an embodiment, the touch control pen drive circuit 132 includes a touch control pen wiring 1321, where touch control pen wirings 1321 are in one-to-one correspondence with the second signal wirings.

A switch element 1322 is arranged on the touch control pen wiring 1321, and the switch element 1322 is used for controlling the connection and disconnection of the touch control pen drive circuit 132 and the touch control electrode 11.

In an embodiment, the touch control apparatus 100 further includes an identification module for recognizing a touch state of the touch control apparatus 100.

In a stylus touch state, switch elements 1322 are in communication, and the touch control pen detection circuit operates. In a non-stylus touch state, the switch elements 1322 are opened, and the non-touch control pen detection circuit operates.

In an embodiment, the identification module includes a capacitive detection unit for detecting whether capacitance is generated at the touch control electrode 11 or not.

A capacitance is formed between the touch control pen and the touch control electrode 11 under a stylus touch state. When the capacitive detection unit detects that the capacitance information exists at the touch control electrode 11, the switch element 1322 is turned on, and the touch control pen detection circuit works. The touch control drive circuit 131 and the touch control pen drive circuit 132 provide driving and signals. The micro-current is fed back to the second signal wirings 122 at two ends according to the position of the touch control electrode set in which the control pen is located, so that the position of the touch control pen is determined.

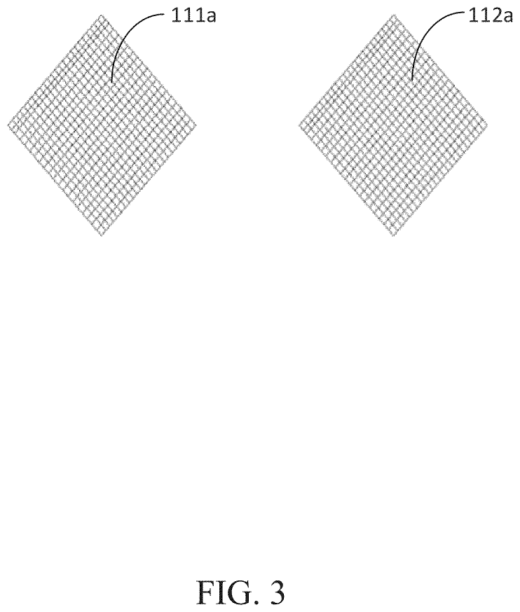

Please refer to FIG. 3. FIG. 3 is a schematic structural diagram of a first touch control electrode unit 111a and a second touch control electrode unit 112a according to a third embodiment of the present disclosure.

In an embodiment, the first touch control electrode unit 111a and the second touch control electrode unit 112a are a diamond-shaped grid electrode.

In an embodiment, the touch control electrode 11 includes a touch control pen sensing layer in a time-sharing mode, the touch control electrode 11 has a relatively dense metal mesh grid compared with an existing touch control pen sensing layer, and the signal precision of the touch control pen can be improved.

In an embodiment, the touch control apparatus 100 further includes a binding pad 14, and the binding pad 14 is arranged between the signal wiring 12 and the driving circuit 13 for connecting the signal wiring 12 with the driving circuit 13, thereby facilitating aggregation and fixation of the signal wirings 12.

According to another aspect of the present disclosure, the present disclosure further provides a touch control driving method of the touch control apparatus 100, the touch control apparatus 100 includes a touch control electrode 11, a signal wiring 12, and a driving circuit 13, where the driving circuit 13 includes a touch control drive circuit 131 and a touch control pen drive circuit 132.

The touch control electrode 11 and the signal wiring 12, the touch control drive circuit 131, and the touch control pen drive circuit 132 are configured to form a touch control pen detection circuit, where the touch control electrode 11, the signal wiring 12, and the touch control drive circuit 131 are configured to form a non-touch control pen detection circuit.

The touch control driving method includes the steps of:

At step S10, performing touch control on the touch control apparatus 100.

At step S20, the touch control apparatus 100 determines the touch control state, and the driving circuit 13 transmits a control signal to the touch control electrode 12 and identifies a touch position.

In a stylus touch state, the touch control pen detection circuit operates. In a non-stylus touch state, the non-touch control pen detection circuit operates.

In an embodiment, the touch control electrode 11 includes a first touch control electrode set 111 and a second touch control electrode set 112 that are insulated from each other.

The first touch control electrode set 111 includes at least two first touch control electrode units 111a that are communicated with each other, where the first touch control electrode set 111 is arranged in a first direction.

The second touch control electrode set 112 includes at least two second touch control electrode units 112a that are communicated with each other, where the second touch control electrode set 112 is arranged in a second direction.

In an embodiment, the first touch control electrode units 111a and the second touch control electrode units 112a are metal grids, and two ends of each set of the first touch control electrode sets 111 and two ends of each set of the second touch control electrode sets 112 are led out of the second signal wirings 122 to be connected with a touch control pen drive circuit 132, e.g., a stylus drive circuit.

In an embodiment, the first touch control electrode unit 111a is an induction electrode and the second touch control electrode unit 112a is a driving electrode.

In an embodiment, the touch control apparatus 100 further includes an insulating layer and a bridging layer.

The insulating layer is arranged on the touch control electrode 11, wherein the material of the insulating layer includes one of silicon nitride and silicon oxide.

The bridging layer is arranged on the insulating layer, and the preparation material of the bridging layer includes conductive metal.

The first touch control electrode units 111a are communicated with each other, and the adjacent second touch control electrode units 112a are communicated through the bridging layer.

In an embodiment, the touch control electrode 11 is disposed on a substrate.

In an embodiment, the touch control apparatus 100 further includes a protection layer arranged on the bridge connection layer.

In an embodiment, the bridging layer and the signal wiring 12 are arranged in a same layer.

In an embodiment, the touch control electrode 11 is connected with the driving circuit 13 through the signal wiring 12.

In an embodiment, the touch control circuit and the touch control pen drive circuit 132 are all arranged on a circuit board of the display panel.

In an embodiment, each of the signal wirings 12 includes a first signal wiring 121 and a second signal wiring 122, the touch control electrode 11 is connected with the touch control drive circuit 131 through the first signal wiring 121, the touch control electrode 11 is connected with the touch control pen drive circuit 132 through the second signal wiring 122.

In an embodiment, the touch control pen drive circuit 132 includes a touch control pen wiring 1321, where touch control pen wirings 1321 are in one-to-one correspondence with the second signal wirings.

A switch element 1322 is arranged on the touch control pen wiring 1321, and the switch element 1322 is used for controlling the connection and disconnection of the touch control pen drive circuit 132 and the touch control electrode 11.

In an embodiment, the touch control apparatus 100 further includes an identification module for recognizing a touch state of the touch control apparatus 100.

In a stylus touch state, switch elements 1322 are in communication, and the touch control pen detection circuit operates. In a non-stylus touch state, the switch elements 1322 are opened, and the non-touch control pen detection circuit operates.

In an embodiment, the identification module includes a capacitive detection unit for detecting whether capacitance is generated at the touch control electrode 11 or not.

A capacitance is formed between the touch control pen and the touch control electrode 11 under a stylus touch state. When the capacitive detection unit detects that the capacitance information exists at the touch control electrode 11, the switch element 1322 is turned on, and the touch control pen detection circuit works. The touch control drive circuit 131 and the touch control pen drive circuit 132 provide driving and signals. The micro-current is fed back to the second signal wirings 122 at two ends according to the position of the touch control electrode set in which the control pen is located, so that the position of the touch control pen is determined.

In an embodiment, the first touch control electrode unit 111a and the second touch control electrode unit 112a are a diamond-shaped grid electrode.

In an embodiment, the touch control electrode 11 includes a touch control pen sensing layer in a time-sharing mode, the touch control electrode 11 has a relatively dense metal mesh grid compared with an existing touch control pen sensing layer, thereby improving the signal precision of the touch control pen.

In an embodiment, the binding pad 14 is arranged between the signal wiring 12 and the driving circuit 13 for connecting the signal wiring 12 with the driving circuit 13, thereby facilitating aggregation and fixation of the signal wirings 12.

The present disclosure has following beneficial effects: the touch control electrode is configured to be time-division multiplexing, so that the touch control electrode can be driven by the touch control drive circuit, and can also be driven by the touch control pen drive circuit. The touch control electrode is used for sensing the position of the touch control pen, so that the touch control pen sensing layer is omitted. The thickness of the touch control apparatus can be reduced, the induction signals of the touch control pen can be improved, and the product cost can be reduced.

As is understood by a person skilled in the art, the foregoing preferred embodiments of the present disclosure are illustrative rather than limiting of the present disclosure. It is intended that they cover various modifications and similar arrangements be included within the spirit and scope of the present disclosure, the scope of which should be accorded the broadest interpretation so as to encompass all such modifications and similar structures.

What is claimed is:

1. A touch control apparatus, comprising:
a touch control electrode;
a signal wiring;
a driving circuit comprising a touch control drive circuit and a touch control pen drive circuit;
wherein the touch control electrode, the signal wiring, the touch control drive circuit, and the touch control pen drive circuit are configured to form a touch control pen detection circuit, and wherein the touch control electrode, the signal wiring and the touch control drive circuit are configured to form a non-touch control pen detection circuit.

2. The touch control apparatus according to claim 1, wherein the signal wiring comprises a first signal wiring and a second signal wiring, and the touch control electrode is connected with the touch control drive circuit through the first signal wiring, and the touch control electrode is connected with the touch control pen drive circuit through the second signal wiring.

3. The touch control apparatus according to claim 2, wherein the touch control pen drive circuit comprises a touch control pen wiring, and the touch control pen wires is in one-to-one correspondence with the second signal wirings;
wherein a switch element is arranged on the touch control pen wiring, and the switch element is used for controlling the connection and disconnection of the touch control pen drive circuit and the touch control electrode.

4. The touch control apparatus according to claim 3, wherein the touch control apparatus further comprises an identification module for identifying a touch state of the touch control apparatus;
wherein in a stylus touch state, the switch element is in communication and a touch control pen detection circuit operates, and in a non-stylus touch state, the switch element is opened and a non-touch control pen detection circuit operates.

5. The touch control apparatus according to claim 4, wherein the identification module comprises a capacitance detection unit for detecting whether a capacitance is generated at a touch control electrode or not.

6. The touch control apparatus according to claim 1, wherein the touch control apparatus further comprises a binding pad, and the binding pad is arranged between the signal wiring and the driving circuit.

7. The touch control apparatus according to claim 2, wherein the touch control electrode comprises a first touch control electrode set and a second touch control electrode set that are insulated from each other;
wherein the first touch control electrode set comprises at least two first touch control electrode units that are communicated with each other, where the first touch control electrode set is arranged in a first direction;
wherein the second touch control electrode set comprises at least two second touch control electrode units that are communicated with each other, the second touch control electrode set is arranged in a second direction;
wherein the first touch control electrode units and the second touch control electrode units are metal grids, and two ends of the first touch control electrode set and two ends of the second touch control electrode set are led out of the second signal wirings to be connected with the touch control pen drive circuit.

8. The touch control apparatus according to claim 7, further comprising an insulating layer and a bridging layer;
wherein the insulating layer is arranged on the touch control electrode;
wherein the bridge layer is arranged on the insulating layer;
wherein first touch control electrode units are communicated, and adjacent second touch control electrode units are communicated through the bridging layer.

9. The touch control apparatus according to claim 7, wherein the first touch control electrode unit and the second touch control electrode unit are a diamond-shaped grid electrode.

10. A touch control driving method of a touch control apparatus, wherein the touch control apparatus comprises a touch control electrode, a signal wiring, and a driving circuit, and the driving circuit comprises a touch control driving circuit and a touch control pen driving circuit;
wherein the touch control electrode, the signal wiring, the touch control drive circuit, and the touch control pen drive circuit are configured to form a touch control pen detection circuit, and wherein the touch control electrode, the signal wiring and the touch control drive circuit are configured to form a non-touch control pen detection circuit;
the touch control driving method comprising the steps of:
at a step S10, performing touch control on the touch control apparatus;
at a step S20, determining, by the touch control apparatus, the touch control state, and transmitting, by the driving circuit, a control signal to the touch control electrode, and identifying a touch position;
wherein in a stylus touch state, the touch control pen detection circuit operates, and in a non-stylus touch state, the non-touch control pen detection circuit operates.

11. A touch control display panel comprising a touch control apparatus and a display panel, the touch control apparatus comprising:
a touch control electrode;
a signal wiring;
a driving circuit comprising a touch control drive circuit and a touch control pen drive circuit;
wherein the touch control electrode, the signal wiring, the touch control drive circuit, and the touch control pen drive circuit are configured to form a touch control pen detection circuit, and wherein the touch control electrode, the signal wiring and the touch control drive circuit are configured to form a non-touch control pen detection circuit.

12. The touch control display panel according to claim 11, wherein the signal wiring comprises a first signal wiring and a second signal wiring, and the touch control electrode is connected with the touch control drive circuit through the first signal wiring, and the touch control electrode is connected with the touch control pen drive circuit through the second signal wiring.

13. The touch control display panel according to claim 12, wherein the touch control pen drive circuit comprises a touch control pen wiring, and the touch control pen wires is in one-to-one correspondence with the second signal wirings;
wherein a switch element is arranged on the touch control pen wiring, and the switch element is used for controlling the connection and disconnection of the touch control pen drive circuit and the touch control electrode.

14. The touch control display panel according to claim 13, wherein the touch control apparatus further comprises an identification module for identifying a touch control state of the touch control apparatus;
wherein in a stylus touch state, the switch element is in communication and the touch control pen detection circuit operates, and in a non-stylus touch state, the switch element is opened and the non-touch control pen detection circuit operates.

15. The touch control display panel according to claim 14, wherein the identification module comprises a capacitance detection unit for detecting whether a capacitance is generated at a touch control electrode or not.

16. The touch control display panel according to claim 11, further comprising a binding pad, and the binding pad is arranged between the signal wiring and the driving circuit.

17. The touch control display panel according to claim 12, wherein the touch control electrode comprises a first touch control electrode set and a second touch control electrode set that are insulated from each other;
wherein the first touch control electrode set comprises at least two first touch control electrode units that are communicated with each other, where the first touch control electrode set is arranged in the first direction;
wherein the second touch control electrode set comprises at least two second touch control electrode units that are communicated with each other, the second touch control electrode set is arranged in a second direction;
wherein the first touch control electrode and the second touch control electrode are metal grids, and the two ends of the first touch control electrode set and the two ends of the second touch control electrode set are led out of second signal wirings are connected with the touch control pen drive circuit.

18. The touch control display panel according to claim 17, further comprising an insulating layer and a bridging layer;
wherein the insulating layer is arranged on the touch control electrode;
wherein the bridge layer is arranged on the insulating layer;
wherein the first touch control electrode units are communicated, and adjacent second touch control electrode units are communicated through the bridging layer.

19. The touch control display panel according to claim 17, wherein the first touch control electrode unit and the second touch control electrode unit are a diamond-shaped grid electrode.
